(19) United States
(12) Patent Application Publication
(10) Pub. No.: US 2009/0211472 A1
(43) Pub. Date: Aug. 27, 2009

(54) GRAVURE PRINTING METHOD WITH EXCHANGEABLE PRINTING PLATE

(76) Inventors: Rainer ENDRES, Karsbach (DE); Peter SCHMITT, Wuerzburg (DE)

Correspondence Address: K.F. ROSS P.C., 5683 RIVERDALE AVENUE, SUITE 203 BOX 900, BRONX, NY, 10471-0900, US

(21) Appl. No.: 12/389,411

(22) Filed: Feb. 20, 2009

(30) Foreign Application Priority Data
Feb. 26, 2008 (DE) 102008011203.8

(51) Int. Cl. B41F 9/00

(52) U.S. Cl. 101/153

(57) ABSTRACT

A gravure printing system has a roll body extending along and rotatable about a roll axis and formed with a radially outwardly open and axially extending recess. The roll body has an outer surface with a region outside the surface lying on a cylinder centered on the axis. A generally part-cylindrical printing plate fitted over the roll body has angularly adjacent ends extending radially into the recess. These ends of the plate are fastened to the roll body in the recess. The plate also has an outer surface with a part-cylindrical central part centered on the axis and a pair of end parts flanking the recess and angled inward from the central part so as to define with the axis radii that are increasingly shorter from the central part to the recess.

### FIELD OF THE INVENTION

The present invention relates to gravure or intaglio printing. More particularly this invention concerns a rotogravure printing apparatus using an exchangeable printing plate.

### BACKGROUND OF THE INVENTION

In standard gravure printing, for instance for printing on a substrate that can be individual sheets, a paper strip, a CD, or a DVD, it is standard to use a printing roll that is cylindrical and rotated about its axis. The outer surface of the roll is formed with a complex array of outwardly open pits or cells that form the image or writing to be printed. The cells are filled with ink by application of liquid ink directly to the surface, then scraping-off of excess ink on the lands between the cells, and then rolling the roll over the substrate to transfer the ink in the cells to the substrate. Such gravure printing is one of the printing methods by means of which the highest print qualities can be achieved. The individual print cells are mechanically engraved, for example, by means of a diamond stylus, into a ductile copper layer that has been previously applied to the surface of the print roll, a more or less deep print cell resulting depending on the striking frequency and striking force.

For the production of the print rolls, blanks are equipped with a ductile copper layer on their surfaces in a first step, such as by means of galvanic precipitation. Subsequently, the print roll blanks prepared in this manner are mounted in a device and rotated about the longitudinal axis thereof at a predetermined speed or one that can be predetermined. An engraver having one or multiple diamond styluses acting upon the exterior of the surface now strikes one or more cells into the copper layer synchronous with the rotation of the print roll in accordance with a print image and a corresponding adjustment to the respective roll geometry for each print cell to be printed such that a first print line is created on the surface of the print roll after rotation of the print roll.

Due to the fact that the engraver simultaneously carries out an intermittent or continuous movement toward the print roll axis it is possible to equip the entire print roll surface with a impressed print image.

The surface of the print roll produced in such manner may also be subsequently polished in order to remove any protruding burrs, and in order to be subsequently galvanically coated with a hard chrome layer in a subsequent step, by means of which the mechanical influences of the transfer rolls and/or color rolls and/or doctor blades, etc. acting upon the surface during the printing operation are reduced, thus increasing the service life of the print roll.

Inking of the print roll completed in this manner in the printing unit of a printing machine may be done, for example, by dipping the surface of the print roll into the printing ink in an ink bath, by means of which, among others, the print cells of the print surface having been formed on the surface are filled with ink. Since the print cells are to contribute to the printed impression exclusively, the surface of the print roll is scraped with a doctor blade while rotating it out of the ink bath so that any excess printer ink is removed. Furthermore, it is often necessary to additionally clean the non-printing region of the surface of the print roll using wipers in order to eliminate any remaining ink residue on the non-printing regions of the print roll after scraping with a doctor blade, which may lead to undesired toning or undesired color stains in the printed impression.

It becomes obvious that the production of such a print roll is a long and tedious process, and the costs involved in producing such a print roll are correspondingly high. Furthermore, changing such a print roll takes quite some time, since the print roll must be exchanged in its entirety, which is often accompanied by problems in print rolls having print lengths of more than one meter and a diameter of frequently 40 cm to 60 cm, and a subsequent readjustment of the printing unit is required. Despite the high printing quality achieved, gravure printing is therefore utilized only in the case of very high-end printing and/or in the case of specialty printing applications.

It is therefore highly desirable to be able to also utilize this type of printing technique in smaller printing editions in a cost-effective manner, both with regard to the production of the print rolls and to a reduced time and effort with regard to changing them in the printing unit.

### OBJECTS OF THE INVENTION

It is therefore an object of the present invention to provide an improved gravure printing apparatus with exchangeable printing plate.

Another object is the provision of such an improved gravure printing method with exchangeable printing plate that overcomes the above-given disadvantages, in particular that is quite flexible and that can be cost effective even with small print runs and that provides a quick switchover from one print job to the next.

### SUMMARY OF THE INVENTION

A gravure printing system has according to the invention a roll body extending along and rotatable about a roll axis and formed with a radially outwardly open and axially extending recess. The roll body has an outer surface with a region outside the surface lying on a cylinder centered on the axis. A generally part-cylindrical printing plate fitted over the roll body has angularly adjacent ends extending radially into the recess. These ends of the plate are fastened to the roll body in the recess. The plate also has an outer surface with a part-cylindrical central part centered on the axis and a pair of end parts flanking the recess and angled inward from the central part so as to define with the axis radii that are increasingly shorter from the central part to the recess.

A printing method according to the invention therefore entails using an exchangeable at least partially cylindrical printing plate comprising the print surface that is clamped to the surface of the roll body of a print roll, and an ink chamber that is opened and closed as a function of the angular position of the print roll for transferring the printing ink coming from the ink chamber onto the printing plate.

Particularly in the application for gravure printing an essential central idea of the invention is that instead of a print roll commonly used in gravure printing, a printing plate is now utilized according to the invention that can be attached to a print roll body that is permanently installed in a printing machine, thus forming a print roll in the entirety, and which may also be changed in a simple manner. The object is further attained in that for the inking of the printing plate according to the invention an ink applicator is utilized for the direct inking of the printing plate.

The invention therefore describes in summary a printing method, particularly a gravure printing method, having an exchangeable printing plate, particularly a printing plate whose image-carrying surface has print cells or printed lines of varying depth and/or of varying surface sizes, and/or ink-holding and/or ink-rejecting regions for transferring printing ink onto the substrate to be printed during gravure printing for creating various optical densities within the printed impression.

According to the invention the printing plate has the properties required for gravure printing during gravure printing, such as a variable print cell shape and/or print cell depth and/or a gridless and/or gridded print-cell arrangement. Preferably the printing plate has a surface hardness and surface quality as is common in gravure printing. According to the invention the ink applicator has an ink reservoir for transferring the printing ink to the printing plate surface, particularly a reservoir connected to an ink supply.

According to the invention the ink applicator has at least one working blade and one closing blade on the side thereof facing the printing plate, which may be displaceable toward each other in a preferred further improvement, and by means of which a gap formed by the outer edges of the blades facing the printing plate may be optionally closed or opened.

In a further preferred embodiment the outer edges facing the printing plate of the working blade and of the closing blade of the ink applicator particularly may be optionally lifted from the printing plate in order, for example, to coat an area of the print roll formed because of the fasteners required for the printing plate without any problems on rotation of the print roll about its longitudinal axis.

In one embodiment in accordance with the invention active closing of the blades, or moving the entire closed ink applicator, respectively, away from the roll, or from the printing plate attached thereto by means of an actuator such that the area having the fasteners may rotate underneath the ink applicator in this retracted position. Subsequently, the return movement can be effected by the actuator.

In another embodiment the invention may also provide that the closed blades or the closed ink applicator remain stationary relative to the pivot axis of the print roll, or of the printing plate attached thereto, and a lifting of the blades from the surface of the printing plate occurs in that the surface of the printing plate moves away from the stationary blades.

This may occur, for example, in that the print roll, or the printing plate attached thereto is of continuously decreasing radius at a predetermined angular region, particularly between the second and third angular positions, and is in particular reduced as compared to surface regions of the printing plate contributing to the printed impression. To this end in accordance with the invention the predetermined angular region of the print roll, or of the printing plate is arranged particularly symmetrically about the attachment area of the print roll, or printing plate particularly symmetrically about a recess forming the attachment area, or receiving attachment means. The angularly extending region may, for example, be extend about the attachment area/recess at a smaller angle, plus/minus 35 to 55 degrees. The angularly extending region may also be asymmetrical on both ends.

The decrease is done such that it occurs from both sides toward the attachment area of the roll, or printing plate. This means that when viewed from the rotation direction, the radius of the roll/printing plate decreases from a maximum radius in the printing area initially toward the attachment area, and subsequently again increases from the attachment area until the maximum radius is again achieved. The radius of the roll or of the printing plate is therefore reduced in an area on both sides adjacent the attachment area/recess and immediately adjacent thereto. To this end the radius reduction in one embodiment may be, for example, 5 to 20%, preferably 8 to 12%, based on the maximum radius in the printing region of the printing plate/roll.

The reduced-radius area of the roll/printing plate that is provided on both sides of the attachment area may be completely identical on both sides, however, the invention may also provide that the radius change of the rotationally trailing are is made smaller, and/or the angular extension is made larger in comparison to the area rotationally leading, particularly in order to achieve a comparatively quick lifting of the blades in the upstream area, and a softer resetting in the downstream area.

In one embodiment it is possible that to both sides of the attachment region between the roll and printing plate the decrease of the radius from the maximum radius takes place smoothly and ends suddenly at an edge in the recess where the printing plate is attached and into which it engages. To this end the invention may also provide to arrange attachment devices and/or clamping devices, and/or adjusting devices for the attachment and/or adjustment of the printing plate such that the outer ends thereof are always at least below the maximum radius.

According to the invention the outer edges of the doctor blades facing the printing plate are set against the printing plate at a predetermined first angular position of the print roll, and the outer edges of the doctor blades are lifted off the surface of the printing plate at a predetermined second angular position of the print roll.

In a preferred further improvement in accordance with the invention for closing of the ink applicator in the angular region between the second angular position and the first angular position, for example, in that the outer edges of the working blade and of the closing blade are pressed against each other, thus closing the gap toward the print roll that is formed by the outer edges of the doctor blades, particularly so that passage printing ink through the gap is prevented between the two angular positions.

In accordance with the invention the positioning of the outer edges of the working blade and of the closing blade in the angular region between the first angular position and the second angular position at a spacing such that a gap is formed, by means of which printing ink may pass through to the surface of the printing plate.

In an advantageous further improvement according to the invention subatmospheric pressure can be applied to the ink reservoir of the ink applicator and/or particularly the area formed by the outer edges of the doctor blades immediately before lifting of the outer edges of the doctor blades from the surface of the printing plate so that printing ink is suctioned back from the surface of the printing plate into the ink applicator.

In accordance with the invention an area formed by the outer edges of the doctor blades is equipped with a plurality of individual conduits to the respective ink reservoir either individually, or in groups. To this end in accordance with the invention the respective ink reservoirs have equal or different printing inks.

In accordance with the invention the use of a printing plate made of metal, such as stainless steel, nickel, etc., or a metal plate equipped with a copper layer, or a metal plate constructed of multiple layers, such as stainless steel, nickel, copper, and chrome.

In accordance with the invention the use of a printing plate made of metal, having a scratch-resistant protective layer, such as a printing plate made of aluminum whose surface has been converted into a scratch-resistant and dense oxide layer or ceramic layer, for example, by means of a plasma process, or for example a printing plate whose surface is coated with a diamond-like carbon layer.

In accordance with the invention the mechanical engraving of the printing plate, for example, is done by means of a engraver that is moved across the surface of the printing plate in a controlled manner to mechanically form print cells in the surface of the printing plate. According to the invention the engraving of the printing plate by means of a laser, for example, in a thermal or chemical manner, or by means of an etching process.

In accordance with the invention a laser for creating different print cell depths and/or print cell sizes may generate individual laser pulses of varying intensity. The laser radiation may particularly be focused on a point in the image plane for creating different print cell depths and/or print cell sizes, or a focal point may be optionally displaced over or under the image plane, particularly by means of a controller. To this end lasers may be utilized, that for example operate in the infrared, visible, or ultraviolet wavelength region.

A printing plate according to the invention may be engraved, for example, in a known manner similar to a conventional gravure printing process in a separate unit such that print cells having a varying arrangement and/or depth can be created. To this end such printing plates have the advantage as compared to the known print rolls that they are produced in a substantially more cost-effective manner, although the production of a gravure printing plate may be more extensive and more cost-intensive in comparison to the production of conventional printing plates, such as offset printing plates or flexoprinting plates.

It is also an advantage that a quick exchange of motifs can be carried out on the printing machine within a few minutes with the use of gravure printing plates, since in this case only light-weight and easy to handle printing plates must be exchanged, and not heavy and hard to handle print rolls as is common according to the prior art.

Furthermore, the required adjustments for obtaining more accurately positioned prints with the use of printing plates can be carried out substantially more quickly and flexibly, since such plates according to the invention can be positioned along and/or transverse to the printing direction via, for example, respective adjusting elements located on the print roll and intended for this purpose, particularly where preferably a tilting may also be adjusted by means of respective adjusting elements such that the required adjustments thus can be made more quickly and accurately, thus imparting substantially greater productivity to a printing machine.

A main focus of the method according to the invention is the inking of the printing plate attached to the print roll, particularly of the gravure printing plate by means of a suitable ink applicator. Since the gravure printing method is usually utilized as a direct printing method for achieving the characteristic gravure printing properties within the printed impression, the gravure printing plate that is preferably attached on the printing cylinder will simultaneously also have the effect of an ink-attracting roll, thus enabling the complete filling of the printing regions formed on the printing plate with ink at varying depth, and therefore at varying ink volumes.

The use of a known ink transfer roll is excluded, since ink transfer rolls have an ink transfer amount that is continuous across the surface thereof, and in case of the use of such an ink transfer roll printing regions of a gravure printing plate, for instance, which have only a very low depth, would therefore be overfilled with ink, whereas printing regions having a high depth would only be filled insufficiently. A resulting printed impression on a printed substrate would therefore represent be unsatisfactory.

The invention therefore provides that the ink applicator for inking the gravure printing plate attached to a printing cylinder is made such that it is positioned against the printing plate only in the region of the printing plate intended for printing, and inks it. In order to attach the gravure printing plate to a print roll body provided therefore, it has mounting devices and/or clamping devices and/or adjusting devices, at least in an area of the surface thereof, particularly along the axis, by means of which the printing plate can be clamped to the surface of the print roll body, particularly, when this body can be aligned at that location, for example, against reference points.

To this end the so-called mounting devices and/or adjusting devices may preferably be positioned, for example, in a recess in the surface of the print roll that extends substantially parallel to the print roll axis. During inking of the gravure printing plate using a conventional ink applicator, printing ink would also reach this recess, which would lead to an unacceptable and undesired contamination of the printing machine.

The invention therefore provides that the ink applicator is made such that an opening facing the printing plate can be closed against transfer of ink onto the printing plate and/or the contact of the printing ink to the printing plate can be interrupted. In this manner it is possible to close the ink applicator toward the printing plate on a rotation of the print roll about the axis thereof, for example, immediately before reaching the recess, and/or to lift it up from the printing plate surface, thus effectively preventing uncontrolled leaking of ink into the recess or contamination of the printing machine.

According to one embodiment at least the outer edges of the doctor blades of the ink applicator are lifted off the surface of the printing plate in the closed state of the ink applicator by means of a suitable actuator immediately after closing the ink applicator and before reaching the recess in the surface of the print roll in order to be able to, for example, rotate the recess past the ink applicator without any problems, and to subsequently set it back against the surface of the printing plate and to open it so that the printing plate in turn can be inked in the usual manner.

The opening and closing of the doctor blades and/or the lifting up of the doctor blades from the gravure printing plate can be carried out, for example, under the control of a cam via respective cam disks attached to the print roll, or, for example, by means of dedicated electric or pneumatic or similar actuator by means of which the times of opening and closing and/or lifting up and replacing can be adjusted in a particularly simple manner, and can optionally be controlled depending on speed.

Furthermore according to the invention the ink applicator is made as a closed ink chamber, at least in areas, so that it is possible to apply subatmospheric pressure to the ink chamber, particularly immediately before closing the ink chamber toward the printing plate, by means of which the printing ink present between the doctor blades on the surface of the printing plate is sucked back into the ink chamber, and by means of which particularly with movement of the doctor blade edges against each other for closing the ink chamber an unacceptable squeezing out of printing ink from the gap formed by the outer edges of the doctor blades and a related undesired contamination of the printing plate and/or the printing machine is avoided.

It may further be advisable to make the ink applicator as a closed chamber, at least in areas, so that it is possible to apply superatmospheric to it, particularly during or immediately after opening of the ink chamber via the doctor blades toward the printing plate, at least at times, by means of which the printing ink reaches the surface of the printing plate more quickly, thus enabling reliable inking of the printing plate even at high rotational speeds of the print roll.

It may further be advisable to apply superatmospheric pressure to the ink chamber, at least at times during the inking process of the printing plate, by means of which a continuous ink transport is ensured onto the printing plate.

To this end the blade angles of the doctor blades on the surface of the printing plate may be made either positive or negative, depending on the requirement, such that a reliable scraping of any excess printing ink from the smooth regions of the printing plate is ensured and in order to achieve the desired printing quality.

In a further embodiment according to the invention it may be provided to make the ink applicator on a side radially close to the print roll with at least two chambers that are separated from each other and that end in a common application gap formed by the outer edges of the doctor blades. In this manner it is possible to apply different printing inks to the printing plate in adjacent zones, by means of which it is possible to do ink-gradient prints. To this end the ink chambers end, for example, within the ink applicator immediately upstream of the gap formed by the outer edges of the doctor blades in a common space in which the printing inks may mix with each other, particularly at the threshold areas thereof.

Due to the fact that the threshold areas have a continuous mix, a continuous ink transition characteristic to ink-gradient printing is created, which may be transferred onto a printing substrate as an image via the printing plate, preferably a gravure printing plate.

It may be advisable to provide additional cleaning devices for the printing plate, by means of which the mixed printing ink is stripped from the printing plate and/or the mixed printing inks are stripped at least off the outer region of the ink applicator in order to, for example, prevent an overly strong mixing of the printing inks, which would adversely influence the desired ink-gradient effect. To this end such cleaning may be carried out in cycles at predetermined time intervals, or according to the number of roll rotations or prints, or also as required.

According to the invention the surface of the printing plate may be acted on by wipers, by means of which regions of the printing plate not to be printed are effectively cleaned of any residual printing ink, and the desired printed impression may thus be transferred to the printing substrate.

### BRIEF DESCRIPTION OF THE DRAWING

The above and other objects, features, and advantages will become more readily apparent from the following description, reference being made to the accompanying drawing in which:

FIG. 1 is a schematic view of a device for the production of gravure printing cylinders according to the prior art;

FIG. 2 is a schematic view of a device for the production of gravure printing plates according to the invention;

FIGS. 3A-D are schematic views of the operating mode of an ink applicator according to the invention;

FIGS. 4A-D are schematic perspective views of the operating mode of an ink applicator according to the invention;

FIG. 5 is a further embodiment according to the invention of an ink applicator.

### SPECIFIC DESCRIPTION

As seen in FIG.

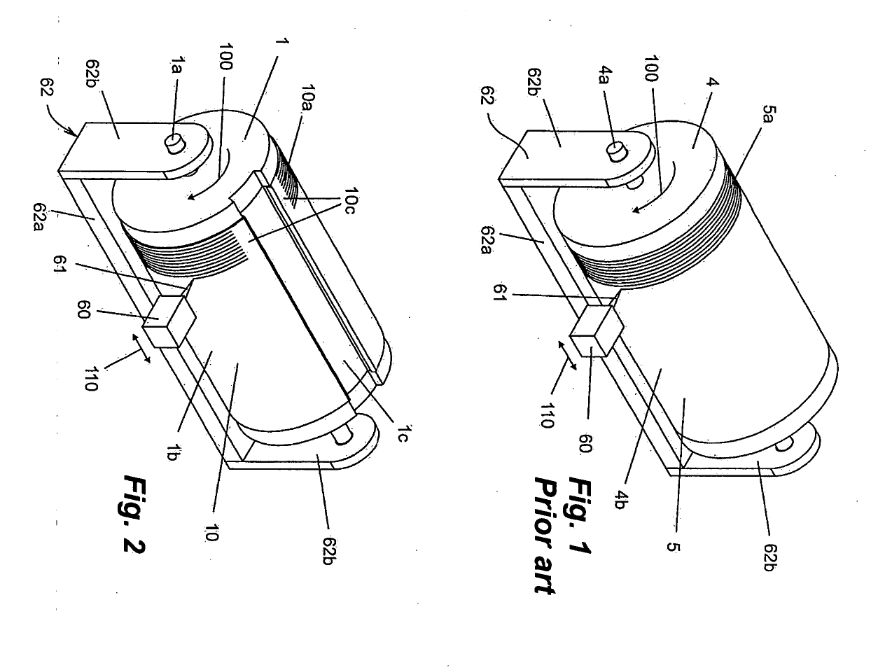

FIG. 1 shows a schematic view of a device for the making conventional gravure print rolls according to the prior art. The print roll 4, for example, is pivotally supported in a holder 62. To this end the holder 62 has, for example, a base 62a and arms 62b by means of which the print roll 4, for example, can be held in a horizontal position, and rotated about a pivot axis 4a in a direction 100 via an unillustrated drive.

An engraver 60 is shiftable parallel to the pivot axis 4a of the print roll 4 such that its stylus 61 may act upon a surface 4b of the print roll 4. To this end the stylus 61 is made, for example, of a diamond or another hard material, and can carry out movements in quick succession toward the outer surface 4b via an electric, or pneumatic, or other type of actuation, by means of which big or small cells are engraved into printed impression regions 5 of the surface 4b of the print roll 4 for creating the different print cells, depending on the strength of the actuating signal.

To this end a printed impression 5a on the print roll 4 may be formed, for example, by moving the engraver 60 parallel to the surface 4b of the printing cylinder 4 and at a substantially constant spacing therefrom along an axis 110. To this end movement of the engraver 60 along the direction 110 may be carried out synchronous to the rotation 100 of the print roll 4, by means of which, for example, a printed impression 5a can be created on the surface 4b in the printed impression region 5 of the print roll that is built up of one spiral printed line.

As an alternative the movement of the engraver 60 may also be carried out in an intermittent manner, in that the engraver 60 is displaced by in steps in the direction 110 after each stepped rotation of the print roll 4. In this manner it is possible to avoid angling of the printed impression 5a created by the spiral arrangement of the printed line, as occurs with a continuous movement of the engraver. The movements of the engraver are also carried out synchronous to rotation of the print roll, and synchronous to the movement of the engraver 60 along the direction 110.

All process steps or technical characteristics described herein may also be utilized in the invention.

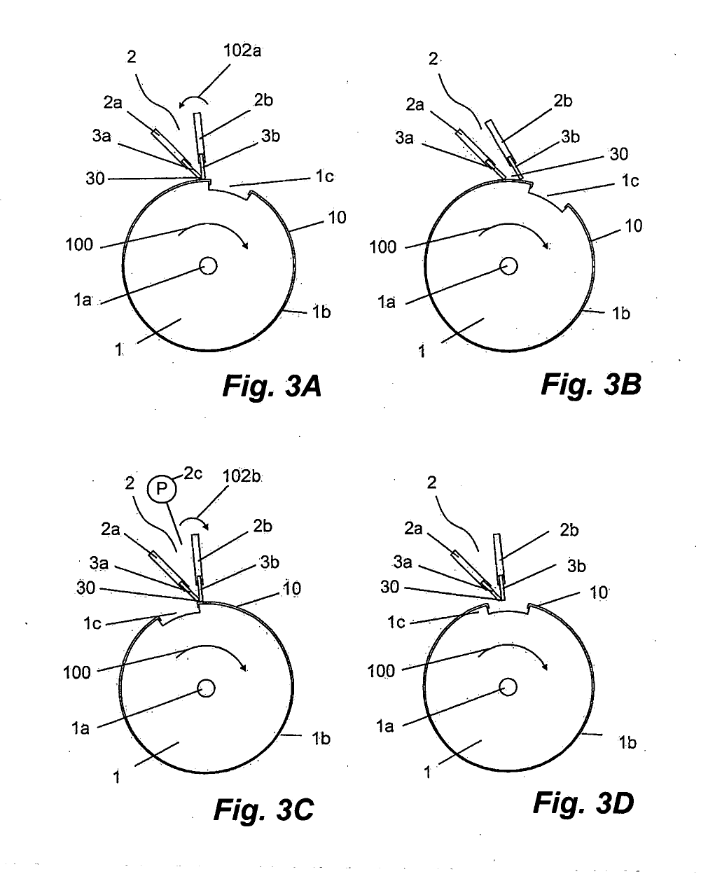

FIG. 2 shows a schematic view for the production of a gravure printing plate 10 according to the invention. To this end the device may be constructed substantially similar to the arrangement described in FIG. 1, the print roll body 1 receiving a printing plate 10 and, for example, being permanently mounted in the holder 62. A print roll is formed by attachment of the at least partly cylindrical printing plate 10 to the roll body 1.

The gravure printing plate 10 in this case is made substantially in the shape of a cylinder, the ends of the gravure printing plate being positioned opposite of each other at a spacing, particularly wherein they are chamfered. The ends form a outer edge and a rear edge of the gravure printing plate 10. Thus, a hollow cylinder is formed having a groove in the surface parallel to the pivot axis 1a between the two edges. Due to this shape a gravure printing plate 10 according to the invention is also somewhat elastic so that it can be stretched and the gravure printing plate may be placed on/pushed onto the roll 1 beyond the mount 62, or in that the printing plate may be wound onto the roll surface 1b.

In order to attach a gravure printing plate 10 to the surface 1b of the roll body 1, the roll body 1 has, for example, a recess 1c on its surface extending parallel to the axis 1a, in which mounting devices and/or clamping devices may be attached, by means of which the gravure printing plate 10 may be retained at the leading and trailing edge thereof, and clamped across the surface 1b of the roll 1. To this end in accordance with the invention the retaining or clamping devices grip and/or clamp the front and rear edge of the gravure printing plate, particularly in order to pull them toward each other.

Inking of the printing plate 10 may be carried out substantially in the same manner as already described, using a continuous or intermittent movement of the engraver 60, at least the attachment area 1c being excluded. To this end it may be advisable to not ink regions 10c on the gravure printing plate 10 that are adjacent the recess 1c, for example, if the print roll has a different shape in this region due to the attachment type of the printing plate 10 on the print roll.

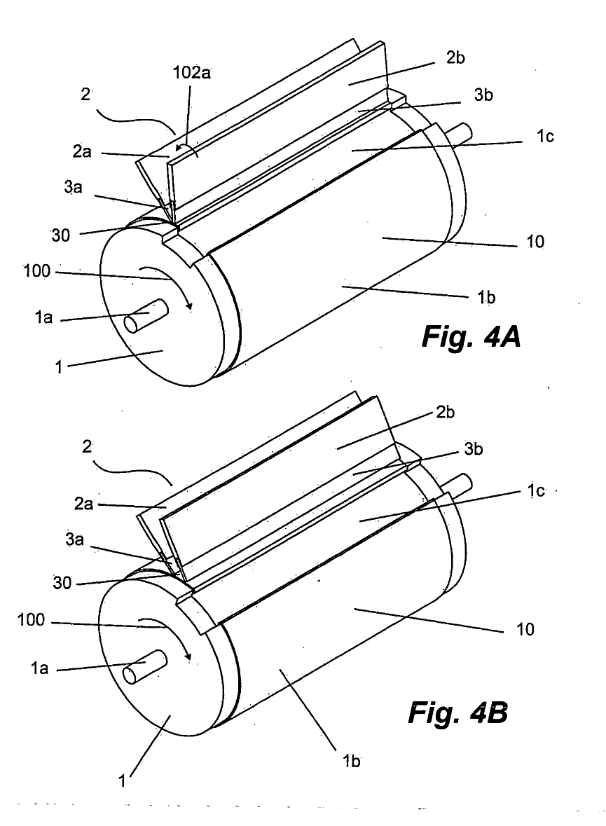

FIGS. 3a to 3d schematically show operating modes of an ink applicator according to the invention during operation. To this end the ink applicator 2 may be constructed substantially as a conventional ink chamber, in that it comprises, for example, two blade beams 2a, 2b to which are attached respective doctor blades 3a, 3b and lateral shields that are not illustrated, by means of which a space, for example, having a substantially triangular cross-section, is formed for holding printing ink. Contrary to a known ink chamber 2 the invention provides that at least one of the blade beams 2a, 2b having a doctor blade 3a, 3b attached thereto is movably supported so that it is possible to close the gap 30 formed between the outer edges of the doctor blades 3a, 3b during operation for the application of printing ink onto the surface 1b of an ink application cylinder or onto a printing plate 10.

FIG. 3A shows the operating mode of the ink applicator according to the invention at a first time during which the outer edges of the doctor blades 3a, 3b are pushed against each other and the opening 30 is closed. On rotation of the roll body 1 in the direction 100 about the axis 1a, the outer edges of the doctor blades are positioned in the first angular position of the roll body 1 shown, for example, on a leading edge of the gravure printing plate 10 as viewed in the rotation direction 100. At this time the gap 30 may be opened by means of a movement, for example, of the movably supported blade beam 2b having the doctor blade 3b attached thereto in a direction 102a such that printing ink reaches the surface of the gravure printing plate from the ink applicator, as is schematically illustrated in FIG. 3B.

On further rotation of the roll body 1 about the pivot axis 1a in the rotation direction 100 the printing plate 10 is inked using printing ink, whereby, for example, the trailing doctor blade 3b acts as a working blade and the leading doctor blade 3a acts as a closing blade.

In a second angular position of the roll body 1, as shown in an example in FIG. 3C, preferably in the trailing region of the gravure printing plate as viewed in the rotation direction 10, the opening 30 may be closed again by means of a movement 102b of the movable blade beam 2b such that no printing ink may leak from the ink applicator toward the roll surface 1b. This ensures that during further rotation of the print roll about the axis 1a in the direction 100 no printing ink reaches the recess 1c, and thus gets into the attachment units for the printing plate 10, as is schematically shown in FIG. 3D.

To this end in accordance with the invention the ink applicator 2 is a closed ink chamber, by means of which the possibility is created to apply superatmospheric pressure to it at least for a predetermined amount of time, for example, during the opening process of the ink applicator 2, as schematically shown by pump P in FIG. 3A, by means of which the printing ink reaches the surface of the gravure plate 10 more quickly from the interior of the ink applicator. Furthermore, it is therefore also possible to apply low pressure to the ink applicator 2 during the closing process, as schematically shown in FIG. 3C, by means of which the printing ink is effectively sucked back into the ink applicator and a squeezing out of printing ink onto the surface of the gravure printing plate 10 from the gap 30 is avoided.

It goes without saying that the blade angles of the doctor blades 3a, 3b shown in FIGS. 3A to 3D are by way of example only, and that the doctor blades may have both positive and negative blade angles.

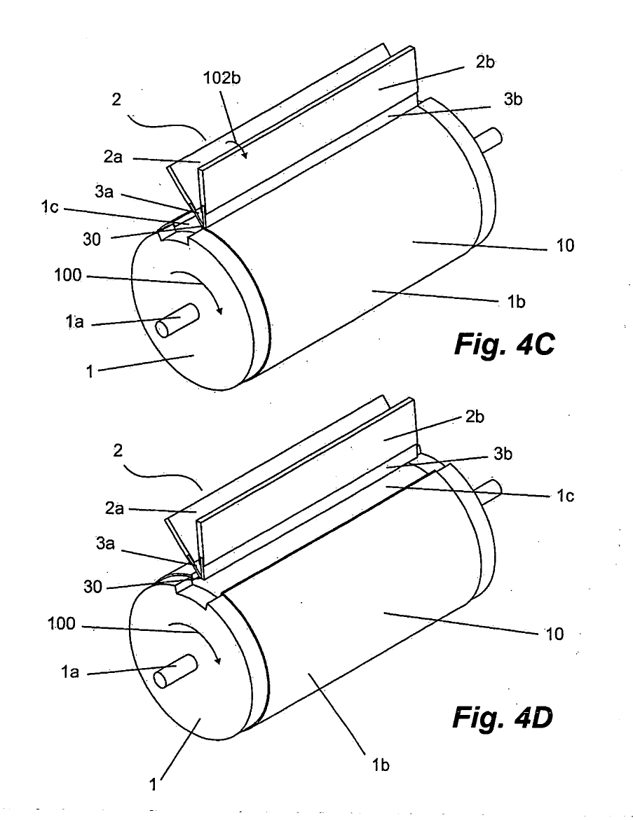

FIGS. 4A to 4B illustrate the described method according to the invention by way of clarification in a schematic perspective view. It is easy to see that upon reaching the beginning of the printing plate 10 on the surface 1b of the print roll as viewed in the rotation direction 100, thus in the first angular position, the outer edges of the doctor blades 3a, 3b are still positioned against each other, and the ink applicator 2 is still closed toward the printing plate 10. At the same time the outer edges of the doctor blades are already positioned on the surface of the printing plate 10 as shown in FIG. 4A such that the ink applicator can be opened, for example, by a movement 102a of the closing blade 3b toward the print roll, by means of which printing ink reaches the printing plate 10 from the interior of the ink applicator 2.

In the same opened state of the ink applicator 2 the printing plate 10 can therefore be inked in the usual manner as shown in FIG. 4B. With further rotation of the print roll 1 as shown in FIG. 4C the doctor blades, and particularly the closing blade 3a initially, reach the trailing end of the printing plate 10 immediately upstream of the recess 1c of the print roll body 1, and the ink applicator 2 is closed, for example, by a movement 102b, for example, of the working blade 3b, toward the ink applicator such that no printing ink can leak from the ink applicator 2 in an uncontrolled manner, and for example, reach the recess 1c.

In this position, from the second angular position, the print roll 1 can be rotated past the ink applicator 2 without any problems, as shown in FIG. 4D. To this end in accordance with the invention whenever the attachment region 1c of the roll body 1 moves past the closed ink applicator, the doctor blades are also lifted from the surface of the gravure printing plate, and are returned to it only for inking the printing region of the gravure printing plate, particularly from upstream of, or at the first angular position.

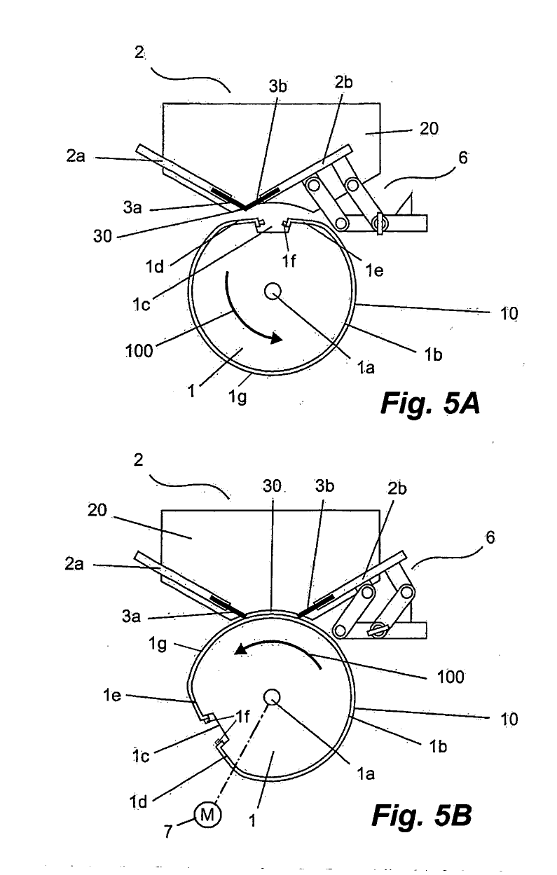

Controlling the movements, for example, of the working blade 3b, can be carried out, for example, by means of a controller and respective sensors, or also by means of a mechanical coupling of the movement device for opening and closing the ink applicator with the drive 7 (FIG. 5B only) of the print roll, for example, via respective cam disks.

FIG. 5A shows a further embodiment according to the invention of an ink applicator for inking a gravure printing plate. To this end the ink applicator 2 has a blade beam 2a having a doctor blade 3a attached thereto, and a blade beam 2b having a doctor blade 3b attached thereto. Here the plate 10 is shown to have bent-in ends that fit flatly against the flanks of the recess 1c and that are secured by fasteners, here bolts if, thereto.

Furthermore, the ink applicator 2 has respective lateral shields 20 on the short ends, by means of which a volume is formed for receiving the printing ink. The ink applicator 2 further has an opening 30 open toward the roll 1, formed between the doctor blade edges, and by means of which printing ink reaches the surface 1b, or the surface of a printing plate 10 clamped onto the surface 1b of the roll 1.

According to the invention the blade beam 2b with the doctor blade 3b is, for example, attached to a device 6 in a movable manner such that the outer edge of the doctor blade 3b abuts the outer edge of the doctor blade 3a in a first position, by means of which the opening 30 formed toward the printing plate 10 is closed, and no printing ink can leak from the ink applicator 2 toward the printing plate 10 in an uncontrolled manner. In the first position a recess 1c located in the roll body 1 is guided underneath and past the ink applicator 2 in the embodiment shown for attaching the printing plate 10, without printing ink reaching the recess 1c, which would lead to an unacceptable contamination.

In accordance with the invention the outer edges of the doctor blades 3a, 3b have no mechanical contact to the roll surface 1b or to the surface of the printing plates not only in the region of the recess 1c of the roll body 1, but also not in the adjacent regions 1d, 1e that extend as bevels lying in respective planes parallel to the axis and angled slightly inward from the cylindrical surface 1b. To this end, for example, the roll radii are continuously reduced in the regions 1d, 1e adjacent the recess 1c and at the angular ends of a cylindrical central region 1g such that the outer edges of the doctor blades steadily and gently lift off the surface of the printing plate 10, and steadily and gently come back down on the surface of the printing plate 10 so that damage to the doctor blade edges or to the printing plate 10 due to abrupt mechanical stresses, particularly with the replacing of the doctor blades on the printing plate 10, are avoided. Thus here the blades 3a and 3b are not themselves moved, but the surface they are riding on is shaped such that it moved inward out of contact with them.

The movement of at least one of the blade beams having doctor blades attached thereto can be carried out, for example, by means of a parallelogrammatic lifter 6, by means of which, for example, the outer edge of the doctor blade acting as a closing blade in FIG. 5A is moved along a circular arc, the radius and position of which may be adjusted to the radius and the position of the printing plate 10 attached to the roll body 1. In this manner the blade angle of the doctor blade 3b on the surface of the printing plate 10, and the blade forces exerted during the closing movement, or during the opening movements, remain substantially equal so that damage to the doctor blade 3b and to the surface of the printing plate 10 is avoided.

FIG. 5B further shows the blade beam 2b having the doctor blade 3b in a second position in which the ink applicator 2 is open toward the surface of the printing plate 10 via the opening 30 of the ink applicator, and printing ink may reach the printing plate 10. In this manner any excess printing ink is scraped off the surface of the printing plate 10 via the working blade 3a in the usual manner, and transported back to the interior of the ink applicator 2 so that only the cells in the printing plate 10 intended for printing are filled with printing ink.

To this end the ink applicator is controlled such that the doctor blades open the ink applicator from a first angular position to a second angular position, and close the ink applicator from the second to the first angular position.

It should be noted with regard to all embodiments that the technical characteristics stated in conjunction with an embodiment may not only be utilized, or are not only utilized in the specific embodiment, but may also be utilized in different embodiments. All disclosed technical characteristics of this description of the invention should be classified as essential to the invention, and can be utilized in any desired combination, or alone. To this end it is understood that the mention of a characteristic being provided, or a process step being performed also means an embodiment of the invention throughout the entire disclosure, in which the respective characteristic is provided, or a respective process step is being performed.

We claim:

1. In a gravure printing system, the improvement comprising:
a roll body extending along and rotatable about a roll axis and formed with a radially outwardly open and axially extending recess, the roll body having an outer surface with a region outside the surface lying on a cylinder centered on the axis;
a generally part-cylindrical printing plate fitted over the roll body and having angularly adjacent ends extending radially into the recess; and
means fastening the ends of the plate to the roll body in the recess, the plate having an outer surface with a part-cylindrical central part centered on the axis and a pair of end parts flanking the recess and angled inward from the central part so as to define with the axis radii that are increasingly shorter from the central part to the recess.

2. The improvement defined in claim 1 wherein the plate is of substantially constant thickness and the roll-body outer surface has a pair of end regions flanking the recess and angled inward from the outer-surface region of the roll body.

3. The improvement defined in claim 2 wherein the end regions of the roll-body outer surface are substantially planar.

4. The improvement defined in claim 1 wherein the recess is an axially extending and radially outwardly open groove having generally radially extending flanks to which the ends of the plate are fastened.

5. The improvement defined in claim 1, further comprising:
an ink applicator comprising a pair of doctor blades extending parallel to the axis and radially engageable with the outer surface of the plate; and
means for rotating the plate about the axis for movement of the outer surface relative to the doctor blades such that the blades lose contact with the plate outer surface as the recess approaches the blades and then regain contact with the plate outer surface after the recess has passed them.

6. The improvement defined in claim 5, further comprising
means for applying a subatmospheric or superatmospheric pressure to the applicator dependent on angular position of the roll body.

7. The improvement defined in claim 5 wherein the blades have outer edges one of which is movable toward the other to close the applicator.

8. The improvement defined in claim 1 wherein the printing plate is a gravure plate and has a gravure surface into which gravure cells are embossed.
